(19) United States
(12) Patent Application Publication
(10) Pub. No.: US 2025/0166267 A1
(43) Pub. Date: May 22, 2025

(54) INTERACTIVE POINT-BASED IMAGE EDITING

(71) Applicant: Lemon Inc., Grand Cayman (KY)

(72) Inventors: Song BAI, Singapore (SG); Yujun Shi, Singapore (SG); Chuhui Xue, Singapore (SG); Wenqing Zhang, Singapore (SG)

(21) Appl. No.: 18/949,486

(22) Filed: Nov. 15, 2024

(30) Foreign Application Priority Data
Nov. 16, 2023 (SG) 10202303236X

(51) Int. Cl. G06T 11/60; G06V 10/48

(52) U.S. Cl. CPC G06T 11/60; G06V 10/48

(57) ABSTRACT

Embodiments of the disclosure relate to interactive point-based image editing. According to example embodiments of the present disclosure, a user edit input for a source image is obtained to indicate at least one handle point and at least one target point in the source image. A feature map is extracted from the source image using a diffusion model at an iteration step of an inverse denoising diffusion process performed on the source image. The feature map is then updated based on the user edit input. Then a target image is generated based on the updated feature map using the diffusion model through a denoising diffusion process performed on the updated feature map.

### CROSS-REFERENCE

The present application claims priority to Singaporean Patent Application 10202303236X, filed on Nov. 16, 2023, and entitled “INTERACTIVE POINT-BASED IMAGE EDITING”, the entirety of which is incorporated herein by reference.

### BACKGROUND

Generating images by image-to-image translation, i.e., modifying an existing image, and image synthesis, i.e., creating an original image with desired characteristics and features, has become increasing popular. Image editing with generative models has attracted extensive attention recently. Such image-to-image translation aims to map images in one domain to another specific domain. Existing methods mainly solve this task via a deep generative model, and focus on exploring a relationship between different domains. The controllability and reliability of those methods need to be further improved.

### SUMMARY

According to implementations of the subject matter described herein, a solution for interactive point-based image editing. In this solution, a user edit input for a source image is obtained to indicate at least one handle point and at least one target point in the source image. A feature map is extracted from the source image using a diffusion model at an iteration step of an inverse denoising diffusion process performed on the source image. The feature map is then updated based on the user edit input. Then a target image is generated based on the updated feature map using the diffusion model through a denoising diffusion process performed on the updated feature map. By usage of the diffusion model, this solution can greatly enhance the applicability of interactive point-based image editing. The user edit input can be applied on the feature map of the diffusion model, which are known to contain rich semantic and geometric information, to achieve precise spatial control.

The Summary is provided to introduce a selection of concepts in a simplified form that are further described below in the Detailed Description. The Summary is neither intended to identify key features or essential features of the subject matter described herein, nor is it intended to be used to limit the scope of the subject matter described herein.

### BRIEF DESCRIPTION OF THE DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, where:

FIG. 1 illustrates a block diagram of an example environment in which various embodiments of the present disclosure can be implemented;

FIG. 2 illustrates a block diagram of an architecture for point-based image editing in accordance with some example embodiments of the present disclosure;

FIG. 3 illustrates a block diagram of an architecture for low rank adaptation (LoRA) fine-tuning in accordance with some example embodiments of the present disclosure;

FIG. 4 illustrates a block diagram of an architecture for latent optimization in accordance with some example embodiments of the present disclosure;

FIG. 5 illustrates an example of feature map updating during the iteration process of the latent optimization in accordance with some example embodiments of the present disclosure;

FIG. 6 illustrates a block diagram of a control mechanical on a self-attention module of the diffusion model in accordance with some example embodiments of the present disclosure;

FIG. 7A illustrate example results on the impact of the inversion step of the feature map to be updated in accordance with some example embodiments of the present disclosure;

FIG. 7B illustrate example results on the impact of the number of LoRA fine-tuning steps in accordance with some example embodiments of the present disclosure;

FIG. 8 illustrates a flowchart of a process for model training in accordance with some example embodiments of the present disclosure; and

FIG. 9 illustrates a block diagram of an example computing system/device suitable for implementing example embodiments of the present disclosure.

### DETAILED DESCRIPTION

Principle of the present disclosure will now be described with reference to some embodiments. It is to be understood that these embodiments are described only for purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for purpose of describing particular embodiments only and is not intended to be limiting example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “model” is referred to as an association between an input and an output learned from training data, and thus a corresponding output may be generated for a given input after the training. The generation of the model may be based on a machine learning technique. The machine learning techniques may also be referred to as artificial intelligence (AI) techniques. In general, a machine learning model can be built, which receives input information and makes predictions based on the input information. For example, a classification model may predict a class of the input information among a predetermined set of classes. As used herein, “model” may also be referred to as “machine learning model”, “learning model”, “machine learning network”, or “learning network,” which are used interchangeably herein.

Generally, machine learning may usually involve three stages, i.e., a training stage, a validation stage, and an application stage (also referred to as an inference stage). At the training stage, a given machine learning model may be trained (or optimized) iteratively using a great amount of training data until the model can obtain, from the training data, consistent inference similar to those that human intelligence can make. During the training, a set of parameter values of the model is iteratively updated until a training objective is reached. Through the training process, the machine learning model may be regarded as being capable of learning the association between the input and the output (also referred to an input-output mapping) from the training data. At the validation stage, a validation input is applied to the trained machine learning model to test whether the model can provide a correct output, so as to determine the performance of the model. Generally, the validation stage may be considered as a step in a training process, or sometimes may be omitted. At the application stage, the resulting machine learning model may be used to process a real-world model input based on the set of parameter values obtained from the training process and to determine the corresponding model output.

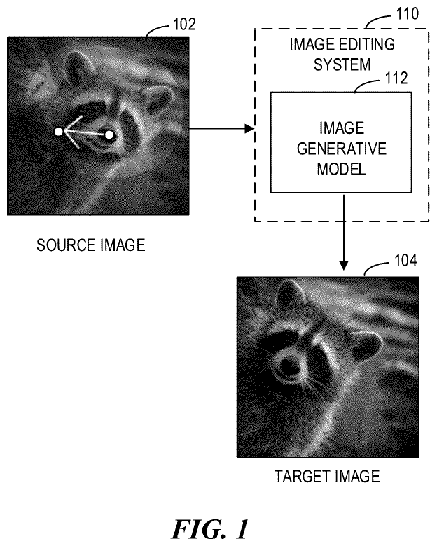

FIG. 1 illustrates a block diagram of an example environment 100 in which various embodiments of the present disclosure can be implemented. The environment 100 involves an image editing scenario, where a source image 102 is to be edited by an image editing system 110, to generate an edited target image 104. The image editing system 110 may utilize an image generative model 112 to generate the target image 104 from the source image 102 based on the user edit input.

Some image generation solution can enable interactive point-based image editing, i.e., drag-based editing. Under this framework, the user first clicks several pairs of handle and target points on the source image 102, as illustrated in FIG. 1. Then, the image generative model 112 performs semantically coherent editing on the image that moves the contents of the handle points to the corresponding target points. In some cases, users can draw a binary mask to specify which region of the source image is editable and which region remains unchanged. The goal of the image editing is to move the feature at the handle points to the target points.

In FIG. 1, the image editing system 110 may include any computing system or device with the computing capability, such as various computing devices/systems, terminal devices, servers, and the like. Terminal devices may include any type of mobile terminal, fixed terminal or portable terminal, including mobile phone, desktop computer, laptop computer, netbook computer, tablet computer, media computer, multimedia tablet, or any combination thereof, including accessories and peripherals of these devices or any combination thereof. Servers include but are not limited to mainframe, edge computing nodes, computing devices in a cloud environment, and the like.

It would be appreciated that the components and arrangements in the environment 100 shown in FIG. 1 are only examples, and a computing system suitable for implementing the example embodiments described in the present disclosure may include one or more different components, other components, and/or different arrangements.

Accurate and controllable image editing is a challenging task. Most of these methods aim to edit the images by manipulating the prompts accompanied with the image. However, as many editing attempts are difficult to convey through text, the prompt-based paradigm usually alters the image's high-level semantics or styles, lacking the capability of achieving precise pixel-level spatial control.

Recently, generative adversarial networks (GAN) have emerged as a powerful tool for generative tasks, and significantly thrive in the field of deep generative models. Some image editing solutions are relied on GAN, to provide an interactive point-based image editing framework that achieves impressive editing results with pixel-level precision. However, due to its reliance on generative adversarial networks (GANs), its generality is limited by the inherent model capacity of pretrained GAN models mainly for two reasons. First, the reliability of GAN-based methods is low, which inevitably limits the capability and flexibility for GAN applications. Previous methods mainly focus on exploring the underlying relationship between different domains, yet neglect to utilize the rich information inside images to boost image translating performance further.

According to embodiments of the present disclosure, there is proposed an improved solution for interactive point-based image editing. In this solution, a user edit input for a source image is obtained to indicate at least one handle point and at least one target point in the source image. A feature map is extracted from the source image using a diffusion model at an iteration step of an inverse denoising diffusion process performed on the source image. The feature map is then updated based on the user edit input. Then a target image is generated based on the updated feature map using the diffusion model through a denoising diffusion process performed on the updated feature map. By usage of the diffusion model, this solution can greatly enhance the applicability of interactive point-based image editing. The user edit input can be applied on the feature map of the diffusion model, which are known to contain rich semantic and geometric information, to achieve precise spatial control.

Some example embodiments of the present disclosure will be described in detail below with reference to the accompanying figures.

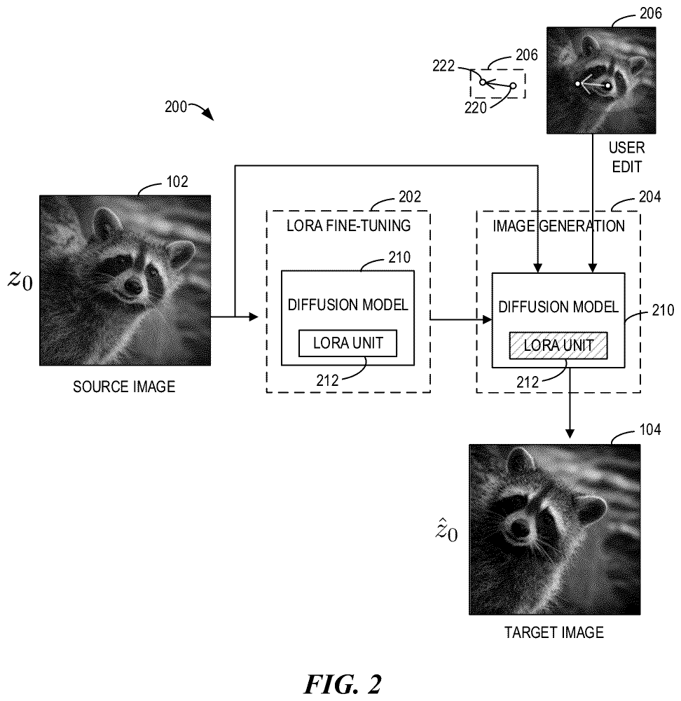

Reference is first made to FIG. 2. FIG. 2 illustrates a block diagram of an architecture 200 for point-based image editing in accordance with some example embodiments of the present disclosure. In the example embodiments of the present disclosure, a diffusion model 210 is applied as an image generative model used for the image editing. The architecture 200 can be implemented at the image editing system 110 of FIG. 1. For purpose of illustration, reference is made to FIG. 1.

Diffusion models are a class of generative models. As a likelihood-based model, the diffusion model matches the underlying data distribution by learning to reverse a noising process, and thus novel images can be sampled from a prior Gaussian noise distribution via the learned reverse path. The example embodiments of the present disclosure enabling a versatile paradigm with diffusion models—interactive point-based image editing, to explore better controllability on diffusion models beyond the prompt-based image editing. Before describing the image editing, the diffusion model is briefly introduced first.

Diffusion model, also known as Denoising Diffusion Probabilistic Model (DDPM), belongs to a family of latent generative models. The mechanism of common generative models (for example, GAN or VAE) is mainly to add information step by step given an input of a “limitation” (for example, type, style, or the like), and finally get the generation result (for example, image). Different from the common generative models, a diffusion model “samples” a special distribution from noise information (for example, Gaussian noise) according to certain conditions step by step, and finally gets the generation result with the increase of “sampling” iterations. In other words, the generation process of diffusion model is to extract required data from noise through multiple iterations, and make sure that the quality of the generated data gets better with the increment of iteration steps. The input of the diffusion model includes Gaussian noise, and the output is the data to be generated.

In general, the modelling of diffusion model includes a denoising diffusion process and an inverse denoising diffusion process. The denoising diffusion process is to generate images by repeatedly removing noise step by step, while the inverse denoising diffusion process is to predict noise by gradually noise addition on images.

Concerning a data distribution q(z), DDPM approximates q(z) as the marginal p_{θ}(z₀) of the joint distribution between Z₀ and a collection of latent random variables Z_{1:T}. Specifically,

$${p}_{θ} ( {z}_{0} ) = \int {p}_{θ} ( {z}_{0 : T} ) {dz}_{1 : T} , \qquad ( 1 )$$

where p_{θ}(z_{T}) is a standard normal distribution and the transition kernels p_{θ}(zₜ₋₁|zₜ) of this Markov chain are all Gaussian conditioned on zt. In the context herein, Z0 corresponds to image samples given by users, and Zt corresponds to the latent code after t iteration steps of the diffusion process.

In some example embodiments, the diffusion model 210 may be a Denoising Diffusion Implicit Model (DDIM). The denoising diffusion process of DDIM may refers to DDIM denoising process, and the inverse denoising diffusion process of DDIM may refers to DDIM inversion process.

In some example embodiments, the diffusion model 210 may be a latent diffusion model (LDM), which maps data into a lower-dimensional space via a variational auto-encoder (VAE) and models the distribution of the latent embeddings instead. Based on the framework of LDM, several powerful pretrained diffusion models have been released publicly, including the Stable Diffusion (SD) model. In SD model, the network responsible for modeling p_{θ}(zₜ₋₁|zₜ) is implemented as a UNet that comprises multiple self-attention and cross-attention modules.

During the image editing according to the embodiments of the present disclosure, a user edit input 206 for the source image 102 is obtained, which at least indicates at least one handle point 220 and at least one target point 222 in the source image 102. In some example embodiments, the user edit input 206 may include several pairs of handle and target points in the source image 102. The user edit input 206 may be obtained through any suitable ways of user instructions. In some example embodiments, the user edit input 206 may further indicate an editable region in the source image 102, which may be provided as a mask specifying the editable region. The user may thus not want other regions in the source image 102 to be changed.

At an image generation state 204, a feature map is extracted from the source image 102 using the diffusion model 210. This feature map is extracted by the diffusion model 210 at an iteration step (at a t-th step) of an inverse denoising diffusion process performed on the source image 102. The inverse denoising diffusion process is to predict noise by gradually noise addition on the source image 102. At each iteration step, a feature map (also referred to as a latent code or a diffusion latent code) is obtained for the source image 102.

Then the feature map extracted at the t-th step of the inverse denoising diffusion process may be updated or optimized based on the user edit input, to obtain an updated feature map. That is, in embodiments of the present disclosure, the diffusion latent code is optimized according to the user instruction (i.e., the handle and target points, and optionally a mask specifying the editable region) to achieve the desired interactive point-based editing. Such an operation is herein called latent optimization.

Usually, the diffusion latent codes can accurately control the spatial layout of the generated images, and rich semantic and geometric information are encoded in the diffusion latent codes. Therefore, these feature information can be used to supervise the latent optimization process. Moreover, considering the Markov chain structure of diffusion latent codes, we focus on optimizing the latent of one single diffusion step, thereby attaining both efficiency and efficacy during the editing.

The target image 104 is generated by the diffusion model 210 based on the updated feature map. The diffusion model 210 may perform a denoising diffusion process performed on the updated feature map, to generate the target image 104.

In some example embodiments, to achieve better generative performance, a low rank adaptation (LoRA) fine-tuning stage 202 is performed before the image generation stage 204. The LoRA fine-tuning stage 202 is to fine-tune a part of the diffusion model 210 for the purpose of better editing the source image 102. The LoRA fine-tuning stage 202 aims to ensure that the diffusion UNet encodes the features of input image more accurately (than in the absence of this procedure), thus facilitating the preservation of the identity of the image throughout the editing process.

The diffusion model 210 may be split as a base model (e.g., a Unet) and a LoRA part 212 connected to the base model. A fine-tuning process is performed on a parameter set of the LoRA part 212 of the diffusion model 210 based on the source image 102. Then the parameter set of the LoRA part 212 is updated, with a parameter set of the base model unchanged. In this way, an updated diffusion model 210 is obtained, with the updated LoRA part 212 for image generation based on the user edit input 206. The extraction of the feature map and the generation of the target image at the image generation stage are based on the updated diffusion model 210.

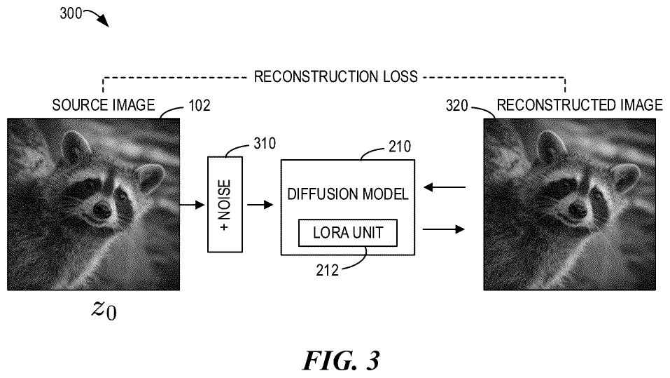

FIG. 3 illustrates a block diagram of an architecture 300 for LoRA fine-tuning of the diffusion model 210 at the LoRA fine-tuning stage 202 in accordance with some example embodiments of the present disclosure. At the LoRA fine-tuning stage 202, a noise signal 310 is added on the source image 102 (which may be provided by the user for editing), to generate a noised image. The fine-tuning process is performed based on a training objective which is configured to cause the updated diffusion model 210 to reconstruct the source image 102 from the noised image. Thus, the noised image is provided as input to the diffusion model 210 (with the LoRA part 212 to be updated), which attempts to reconstruct the source image 102 through a denoising diffusion process by repeatedly removing noise step by step. In this denoising diffusion process, the diffusion model 210 may need to predict the noise added to the source image 102.

A reconstruction loss between a reconstructed image 320 and the source image 102 is determined, which is used as an objective function of the LoRA fine-tuning. The reconstruction loss may be determined as follows:

$${ℒ}_{ft} ( z , Δθ ) = {𝔼}_{e , t} [ {‖ ϵ - {ϵ}_{θ + Δθ} ( {α}_{i} z + {σ}_{i} ϵ ) ‖}_{2}^{2} ] , \qquad ( 2 )$$

where θ and Δ_{θ} represent the parameter set of the base model and the parameter set of the LoRA part, respectively; z is the source image 102; ϵ˜ [symbol] (0, I) is the randomly sampled noise map that is added to the source image 102; ϵ_{θ+Δθ}(·) is the noise map predicted by the diffusion model 210 (with the LoRA part 212 integrated); and αₜ and σₜ are parameters of the diffusion noise schedule at an interaction step t. The training objective of the LoRA fine-tuning is to optimize the reconstruction loss via gradient descent on the parameter set of the LoRA part (i.e., Δθ), to minimize the reconstruction loss or cause the reconstruction loss to be reduced to a desired value. During the fine-tuning process, the parameter set of the base model, θ, will not be changed.

In some example embodiments, the diffusion model 210 may include a number of attention modules among other modules. To enable efficient fine-tuning of the parameters, the LoRA part 212 may comprise at least a part of one or more attention modules comprised in the diffusion model 210. For example, the parameter set of the LoRA part 212 may include the projection matrices of the query, key, and value of attention modules in the diffusion model 210. Moreover, unlike tasks such as subject-driven image generation, which normally fine-tunes the LoRA part for a great number of steps (e.g., around 1000 steps), a small number of steps for fine-tuning the LoRA part (e.g., around 200 steps) is sufficient for in the tasks of image editing in the example embodiments of the present disclosure. This ensures that the LoRA fine-tuning process is extremely efficient.

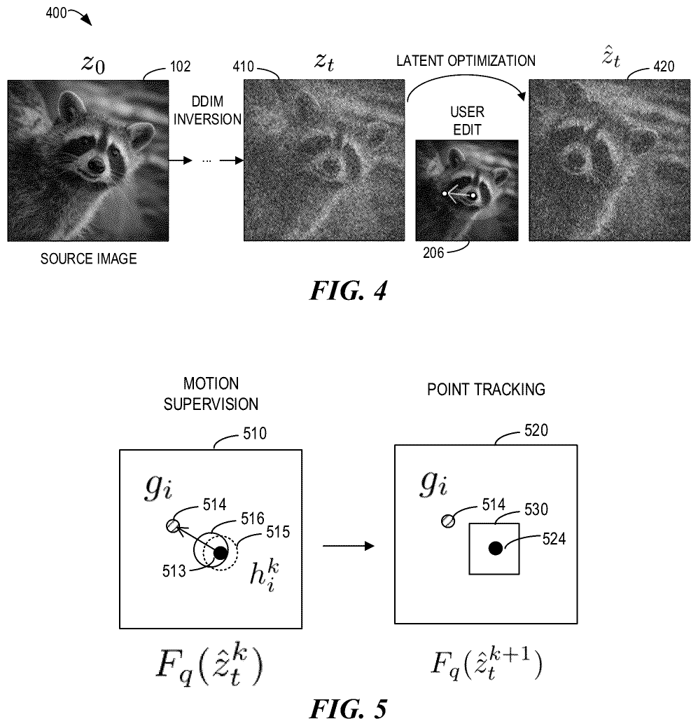

The updated diffusion model 210 is then utilized for image editing on the source image 102, as shown in FIG. 2. As mentioned above, the image editing may include latent optimization on the feature map that is extracted at the t-th iteration step of the inverse denoising diffusion process. FIG. 4 illustrates a block diagram of an architecture 400 for latent optimization in accordance with some example embodiments of the present disclosure.

The latent optimization process is to update the feature map corresponding to an intermediate image 410 extracted at the t-th step in an iteration process based on an optimization objective, the optimization objective being configured to cause a difference between a first feature segment of a first patch around the at least one handle point in the feature map and a second feature segment of a second patch around the at least one target point in the updated feature map to be minimized or to be reduced to a target error. The latent optimization is guided with the user edit input 206, to generate an updated feature map that is corresponding to an intermediate image 420. In some example embodiments where the user edit input further indicates an editable region in the source image 102, the optimization objective may be configured to cause a feature segment corresponding to a region outside the editable region to be unchanged.

To commence, the denoising diffusion process may be applied on the given source image 102 (represented as z0) to obtain an intermediate image 410 (represented as zt) at a certain step t, which may be corresponding to a feature map. This feature map serves as the initial value for the latent optimization process. The latent optimization process consists of two steps to be implemented consecutively. These two steps are motion supervision and point tracking and are executed repeatedly until either all handle points have moved to the target points or the maximum number of iterations has been reached. Next, example embodiments of these two steps are described in detail.

As the user edit input 206 indicates at least one handle point 220 and at least one target point 222 in the source image 102, the goal of the image editing is to move the object in the source image such that the semantic positions (e.g., the nose of the racoon in the example source image) of the handle points reach their corresponding target points.

Given these user inputs, image editing is performed in an optimization manner. As shown in FIG. 5, each optimization step consists of two sub-steps, including 1) motion supervision and 2) point tracking. In motion supervision, a motion supervision loss that enforces the handle points to move towards the target points is used to optimize the feature map. After one optimization step, a new intermediate feature map is obtained and a new intermediate image is also obtained.

The update would cause a slight movement of the object in the image. Note that the motion supervision step only moves each handle point towards its target by a small step but the exact length of the step is unclear as it is subject to complex optimization dynamics and therefore varies for different objects and parts. Thus, the positions of the handle points are then updated to track the corresponding points on the object. This tracking process is needed because if the handle points (e.g., the nose of the raccoon) are not accurately tracked, then in the next motion supervision step, wrong points (e.g., face of the lion) will be supervised, leading to undesired results. After tracking, we repeat the above optimization step based on the new handle points and latent codes. This optimization process continues until the handle points reach the position of the target points, which usually takes 30-200 iterations in our experiments. The user can also stop the optimization at any intermediate step. After editing, the user can input new handle and target points and continue editing until satisfied with the results.

It is denoted the n handle points at the k-th iteration step of the motion supervision as {hᵢ^{k}=(xᵢ^{k}, yᵢ^{k}):i=1, . . . , n} and their corresponding target points as {gᵢ=(\tilde{x}ᵢ, \tilde{y}ᵢ): i=1, . . . , n}. The input source image 102 is denoted as z0; the t-th step intermediate image 410 (i.e., result of t-th step of the denoising diffusion process) is denoted as zt. The feature map(s) corresponding to the t-th step intermediate image 410 is represented as F(zₜ) which is then used for motion supervision. The feature vector at a pixel location hᵢ^{k} as Fₕ_{ᵢ}_{^{k}}(zₜ). Also, a square patch centered around a handle point hᵢ^{k} as

$$Ω ( {h}_{i}^{k} , {r}_{1} ) = \{ ( x , y ) : \vert x - {x}_{i}^{k} \vert \leq {r}_{1} , \vert y - {y}_{i}^{k} \vert \leq {r}_{1} \} .$$

As shown in FIG. 5, at a k-th step of the iteration process for the motion optimization, its input is an intermediate feature map 510 which is the feature map F(zₜ) at an initial step or an intermediate feature map updated from a previous step. A first intermediate feature segment F_{q}(\hat{z}ₜ^{k}) is extracted from a first patch 515 of the intermediate feature map 510 around the at least one handle point 514. The first patch 515 may be a circular region with the handle point 513 as the center and with a predetermined radius r1, e.g., q∈Ω(hᵢ^{k}, r₁). Then a second intermediate feature segment from a second patch 516 of the intermediate feature map 510 around at least one moved handle point in the intermediate feature map. The at least one moved handle point may be moved from the at least one handle point towards the at least one target point 514 by a predetermined distance, di., dᵢ=(gᵢ−hᵢ^{k})/∥gᵢ−hᵢ^{k}∥₂ which is the normalized vector pointing from hᵢ^{k} to gᵢ. Then a motion supervision loss based on a difference between the first intermediate feature segment and the second intermediate feature segment. The intermediate feature map to generate an updated intermediate feature map 520 for a next step by performing gradient backpropagation using the motion supervision loss, wherein a gradient is not backpropagated through the first intermediate feature segment.

In some example embodiments, the motion supervision loss does not rely on any additional neural networks. The idea is that the intermediate feature maps generated during the image generation process are very discriminative such that a simple loss suffices to supervise motion. Specifically, the motion supervision loss at the k-th iteration is defined as:

$${ℒ}_{ms} ( {\hat{z}}_{t}^{k} ) = {\sum }_{i = 1}^{n} {\sum }_{q ∈ Ω ( {h}_{i}^{k} , {r}_{i} )} {‖ {F}_{q + {d}_{i}} ( {\hat{z}}_{t}^{k} ) - sg ( {F}_{q} ( {\hat{z}}_{t}^{k} ) ) ‖}_{1} + λ {‖ ( {\hat{z}}_{t - 1}^{k} - sg ( {\hat{z}}_{t - 1}^{0} ) ) ⊙ ( - M ) ‖}_{1} , \qquad ( 3 )$$

where \hat{z}ₜ^{k} is the t-th step intermediate image after the k-th update; F_{q}(\hat{z}ₜ^{k}) is the intermediate feature map corresponding to the t-th step intermediate image (which may be the feature map Fₕ_{ᵢ}_{^{k}}(zₜ) at an initial step or an intermediate feature map updated from a previous step); sg(·) is the stop gradient operator (i.e., the gradient will not be back-propagated for the term sg(F_{q} (\hat{z}ₜ^{k}))), dᵢ=(gᵢ−hᵢ^{k})/∥gᵢ−hᵢ^{k}∥₂ is the normalized vector pointing from hᵢ^{k} to gᵢ, M is the binary mask specified by the user as the editable region; F_{q+d}_{ᵢ}(\hat{z}ₜ^{k}) is obtained via bilinear interpolation as the elements of q+dᵢ may not be integers.

In each iteration step, is updated by taking one gradient descent step to minimize the motion supervision loss [symbol] ₘₛ:

$${\hat{z}}_{t}^{k + 1} = {\hat{z}}_{t}^{k} - η \cdot \frac{\partial {ℒ}_{ms} ( {\hat{z}}_{t}^{k} )}{\partial {\hat{z}}_{t}^{k}} , \qquad ( 4 )$$

where η is the learning rate for latent optimization.

Note that the second term λ∥(\hat{z}ₜ₋₁^{k}−sg(\hat{z}ₜ₋₁⁰)) ⊙(1−M)∥₁ in Eqn. (3) is defined to encourage the unmasked region to remain unchanged. In this way, the optimization is working with the diffusion latent code instead of other feature information. Specifically, given \hat{z}ₜ^{k}, one step of DDIM denoising is first applied to obtain \hat{z}ₜ₋₁^{k}, and then the unmasked region of \hat{z}ₜ₋₁^{k} is regularized to be the same as \hat{z}ₜ₋₁⁰ (i.e., zₜ₋₁).

Since the motion supervision updates \hat{z}ₜ^{k}, the positions of the handle points may also change. Therefore, point tracking is performed to update the handle points after each motion supervision step. As shown in FIG. 5, at the k-th iteration step, the at least one handle point for the updated intermediate feature map 520 may be updated to be at least one point 524 that is selected a patch 530 among the at least one handle point in the feature map through a nearest neighbor search. The patch 530 may be a square patch with a predetermined side length r2.

To achieve this goal, the feature maps F(\hat{z}ₜ^{k+1}) and F(zₜ) are used to track the new handle points. Specifically, each of the handle points hᵢ^{k} is updated with a nearest neighbor search within the square patch Ω(hᵢ^{k}, r₂)={(x,y): |x−xᵢ^{k}|≤r₂, |y−yᵢ^{k}|≤r₂} as follows:

$${h}_{i}^{k + 1} = {arg min}_{q ∈ Ω ( {h}_{i}^{k} , {r}_{2} )} {‖ {F}_{q} ( {\hat{z}}_{t}^{k + 1} ) - {F}_{{h}_{i}^{0}} ( {z}_{t} ) ‖}_{1} . \qquad ( 5 )$$

The new hand points hᵢ^{k+1} are used for the update of the F(\hat{z}ₜ^{k+1}) at a next iteration step. It is noted that the target point(s) {gᵢ=(\tilde{x}ᵢ,\tilde{y}ᵢ): i=1, . . . , n} remain unchanged during the latent optimization.

After the optimization of the feature map is completed, the optimized feature map may be used to obtain the final editing results, e.g., the target image 104. In some cases, it is found that directly applying DDIM denoising on the optimized feature map still occasionally leads to undesired identity shift and degradation in quality compared to the original image. The reasons raising this issue may be due to the absence of adequate guidance from the original image during the denoising process.

To mitigate this problem, in some example embodiments, controlled processing on one or more self-attention modules contained in the diffusion model 210 is applied. A self-attention module (e.g., based on t) may include a key, a value, and a query as inputs, represented as K, V, Q, respectively. Example processing of the self-attention module may be represented as follows:

$$Attention ( Q , K , V ) = softmax ( \frac{Q . {K}^{T}}{\sqrt{{d}_{k}}} ) . V . \qquad ( 6 )$$

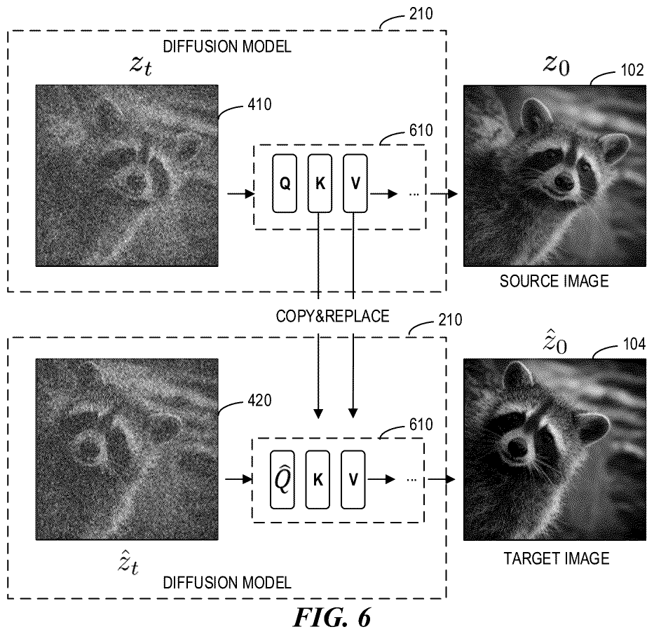

The controlled processing of the self-attention module is illustrated in FIG. 6. In FIG. 6, a self-attention module 610 is illustrated as being comprised in the diffusion model 210. The

A denoising diffusion process is performed on the feature map corresponding to the intermediate image 410 by the diffusion model 210, to obtain a first key, a first value, and a first query (K, V, Q, respectively) for the self-attention module 610. The denoising diffusion process on the feature map corresponding to the intermediate image 410 may result in generating the source image 102.

Further, the denoising diffusion process of the diffusion model 210 is also performed on the updated feature map corresponding to an intermediate image 420, to obtain a second key, a second value, and a second query (\hat{K}, \hat{V}, \hat{Q}, respectively) for the self-attention module 610. Then the first key and first value (K, V) for the feature map are copied and used to replace the second key and second value (\hat{K}, \hat{V}). As a result, the first key, the first value, and the second query (K, V, \hat{Q}) are provided as inputs to the self-attention module 610. Then the target image 104 is generated based on an output of the self-attention module.

In particular, as illustrated in FIG. 6, given the denoising process of both the original latent and the optimized latent \hat{z}ₜ, the process of zₜ is used to guide the process of \hat{z}ₜ. More specifically, during the forward propagation of the self-attention modules of the diffusion model 210 in the denoising process, we replace the key and value vectors generated from \hat{z}ₜ with the ones generated from \hat{z}ₜ. With this simple replacement technique, the query vectors generated from \hat{z}ₜ will be directed to query the correlated contents and texture of zₜ. This result in the denoising results of \hat{z}ₜ (i.e., \hat{z}₀) being more coherent with the denoising results of zₜ(i.e., z₀). In this way, the controlled processing of the self-attention substantially improves the consistency between the original image and our editing results.

It would be appreciated that although one self-attention module 610 is shown in the diffusion model 210, there may be a number of self-attention module layers in the diffusion model 210 and the processing of all or some of the self-attention modules may be controlled in a similar way. In some example embodiments, the diffusion model 210 may include down-sampling blocks and upsampling blocks, each block including one or more self-attention modules. The controlled processing as discussed above may be applied to the self-attention modules in the upsampling blocks of the diffusion model 210. In some example embodiments, the controlled processing of the self-attention modules may be applied at all denoising steps when generating the editing results.

In some example embodiments, the inverse denoising diffusion process comprises a total number of iteration steps, and the feature map is extracted at the t-th iteration step that is within a range of 60% to 80% of the total number of iteration steps. For example, if the total number of iteration steps of the inverse denoising diffusion process is 50, experiments show that a critical range of t values for effective editing is t ∈ [30, 40]. When t is too small, the diffusion latent lacks the necessary flexibility for substantial changes, posing challenges in performing reasonable edits. Conversely, overly large t values result in a diffusion latent that is unstable for editing, leading to difficulties in preserving the original image's identity.

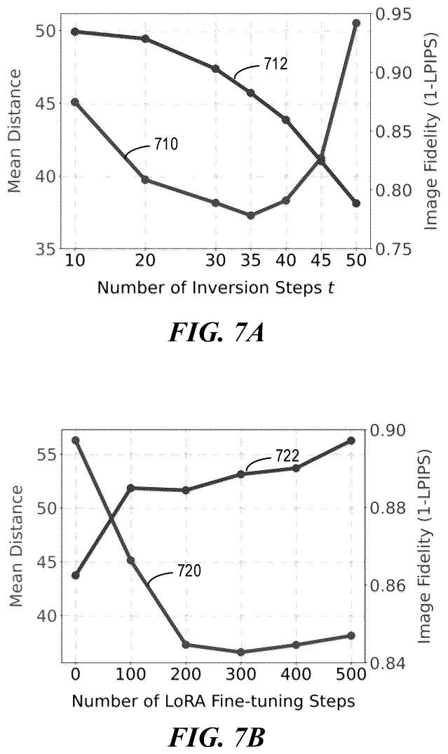

FIG. 7A illustrate example results on the impact of the inversion step of the feature map to be updated in accordance with some example embodiments of the present disclosure. In FIG. 7A, Image Fidelity (IF) and Mean Distance (MD) for each value of the inversion step t. The curve 710 shows the IF results, and the curve 712 shows the MD results. It can be seen that both the IF and MD can reach desired levels within the range of [30, 40].

Further, considering the number of LoRA fine-tuning steps, experiments are performed to examine the influence of varying LoRA fine-tuning steps on the performance of the diffusion model when editing real images. FIG. 7B illustrate example results on the impact of the number of LoRA fine-tuning steps in accordance with some example embodiments of the present disclosure.

Specifically, six different checkpoints of LoRA finetuning are acquired, each trained for a different number of steps, namely, 0, 100, 200, 300, 400, and 500 steps, respectively (0 being no LoRA finetuning). Subsequently, utilizing each of these LoRA checkpoints, the image editing according to some example embodiments of the present discussion is applied using the diffusion model. The outcomes are assessed using IF and MD, and the results are presented in the curves 720 and 722 of FIG. 7B, respectively. As can be seen, as the number of LoRA fine-tuning steps increases, IF exhibits an increasing trend. This behavior is attributed to the enhanced ability of the LoRA to reconstruct the original image with prolonged fine-tuning, resulting in increased consistency with the original image.

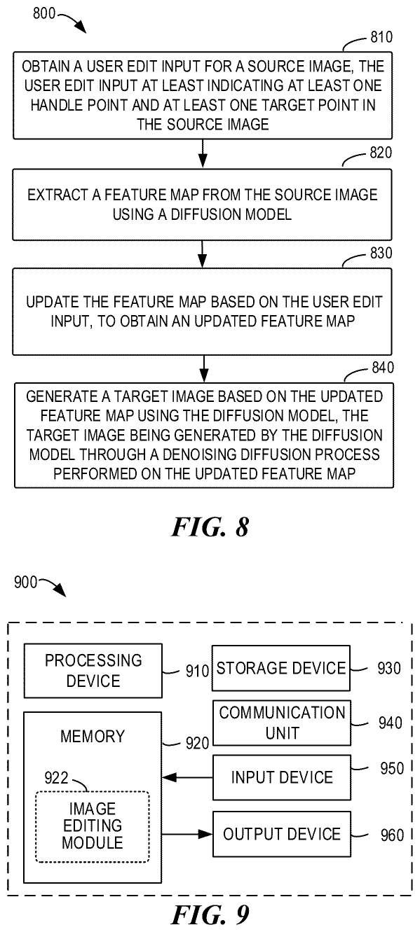

FIG. 8 illustrates a flowchart of a process 800 for image editing in accordance with some example embodiments of the present disclosure. The process 800 may be implemented at the image editing system 110 as illustrated in FIG. 1.

At block 810, the image editing system 110 obtains a user edit input for a source image, the user edit input at least indicating at least one handle point and at least one target point in the source image.

At block 820, the image editing system 110 extracts a feature map from the source image using a diffusion model, the feature map being extracted by the diffusion model at a iteration step of an inverse denoising diffusion process performed on the source image.

At block 830, the image editing system 110 updates the feature map based on the user edit input, to obtain an updated feature map.

At block 840, the image editing system 110 generates a target image based on the updated feature map using the diffusion model, the target image being generated by the diffusion model through a denoising diffusion process performed on the updated feature map.

In some example embodiments, the diffusion model comprises a base model and a low rank adaptation (LoRA) part connected to the base model. The process 800 further comprises: performing, based on the source image, a fine-tuning process on a parameter set of the LoRA part of the diffusion model, with a parameter set of the base model unchanged, to obtain an updated diffusion model, and wherein the extraction of the feature map and the generation of the target image are based on the updated diffusion model.

In some example embodiments, performing the fine-tuning process comprises: performing the fine-tuning process based on a training objective, the training objective being configured to cause the updated diffusion model to reconstruct the source image from a noised image, the noised image being generated by adding a noise signal on the source image.

In some example embodiments, the LoRA part comprises at least a part of one or more attention modules comprised in the diffusion model.

In some example embodiments, updating the feature map based on the user edit input comprises: updating the feature map in an iteration process based on an optimization objective, the optimization objective being configured to cause a difference between a first feature segment of a first patch around the at least one handle point in the feature map and a second feature segment of a second patch around the at least one target point in the updated feature map to be minimized or to be reduced to a target error.

In some example embodiments, the user edit input further indicates an editable region in the source image, and wherein the optimization objective is configured to cause a feature segment corresponding to a region outside the editable region to be unchanged.

In some example embodiments, updating the feature map in an iteration process comprises: at each iteration step of the iteration process, determining a motion supervision loss by: obtaining an intermediate feature map that is the feature map at an initial iteration step or an intermediate feature map updated from a previous iteration step, extracting a first intermediate feature segment from a first patch of the intermediate feature map around the at least one handle point in the intermediate feature map; extracting a second intermediate feature segment from a second patch of the intermediate feature map around at least one moved handle point in the intermediate feature map, the at least one moved handle point being moved from the at least one handle point towards the at least one target point by a predetermined distance; determining a motion supervision loss based on a difference between the first intermediate feature segment and the second intermediate feature segment; updating the intermediate feature map to generate an updated intermediate feature map for a next iteration step by performing gradient backpropagation using the motion supervision loss, wherein a gradient is not backpropagated through the first intermediate feature segment.

In some example embodiments, updating the feature map in an iteration process comprises: updating the at least one handle point for the updated intermediate feature map to be at least one point that is selected a patch among the at least one handle point in the feature map through a nearest neighbor search.

In some example embodiments, the diffusion model comprises a self-attention module with a key, a value, and a query as inputs. In some example embodiments, generating a target image based on the updated feature map using the diffusion model comprises: performing the denoising diffusion process on the feature map by the diffusion model, to obtain a first key, a first value, and a first query for the self-attention module; performing the denoising diffusion process on the updated feature map by the diffusion model, to obtain a second key, a second value, and a second query for the self-attention module; providing the first key, the first value, and the second query as inputs to the self-attention module; and generating a target image based on an output of the self-attention module.

In some example embodiments, the inverse denoising diffusion process comprises a total number of iteration steps, and the feature map is extracted at an iteration step that is within a range of sixty percentage or eighty percentage of the total number of iteration steps.

FIG. 9 illustrates a schematic block diagram of a computing system/device 900 in which various embodiments of the present disclosure can be implemented. It would be appreciated that the computing system/device 900 as shown in FIG. 9 is merely provided as an example, without suggesting any limitation to the functionalities and scope of embodiments of the present disclosure.

As shown in FIG. 9, the computing system/device 900 is in form of a general-purpose computing device. Components of the computing system/device 900 may include, but are not limited to, one or more processors or processing devices 910, a memory 920, a storage device 930, one or more communication units 940, one or more input devices 950, and one or more output devices 960.

In some example embodiments, the computing system/device 900 may be implemented as a device with computing capability, such as a computing device, a computing system, a server, a mainframe and the like.

The processing device 910 can be a physical or virtual processor and can execute various processing based on the programs stored in the memory 920. In a multi-processor system, a plurality of processing units execute computer-executable instructions in parallel so as to enhance parallel processing capability of the computing system/device 900. The processing device 910 may include a central processing unit (CPU), a graphics processing unit (GPU), a microprocessor, a controller, and/or a microcontroller.

The computing system/device 900 usually includes various computer storage media. Such media may be any available media accessible by the computing system/device 900, including but not limited to, volatile and non-volatile media, or detachable and non-detachable media. The memory 920 may be a volatile memory (for example, a register, cache, Random Access Memory (RAM)), non-volatile memory (for example, a Read-Only Memory (ROM), Electrically Erasable Programmable Read-Only Memory (EEPROM), a flash memory), or any combination thereof. The storage device 930 may be any detachable or non-detachable medium and may include computer-readable medium such as a memory, a flash memory drive, a magnetic disk or any other media that can be used for storing information and/or data and are accessible by the computing system/device 900.

The computing system/device 900 may further include additional detachable/non-detachable, volatile/non-volatile memory media. Although not shown in FIG. 9, there may be provided a disk drive for reading from or writing into a detachable and non-volatile disk, and an optical disk drive for reading from and writing into a detachable non-volatile optical disc. In such cases, each drive may be connected to a bus (not shown) via one or more data medium interfaces.

The communication unit 940 implements communication with another computing device via the communication medium. In addition, the functionalities of components in the computing system/device 900 may be implemented by a single computing cluster or a plurality of computing machines that can communicate with each other via communication connections. Thus, the computing system/device 900 may operate in a networked environment using a logic connection with one or more other servers, network personal computers (PCs), or further general network nodes.

The input device 950 may include one or more of a variety of input devices, such as a mouse, keyboard, data import device and the like. The output device 960 may be one or more output devices, such as a display, data export device and the like. By means of the communication unit 940, the computing system/device 900 may further communicate with one or more external devices (not shown) such as storage devices and display devices, one or more devices that enable the user to interact with the computing system/device 900, or any devices (such as a network card, a modem and the like) that enable the computing system/device 900 to communicate with one or more other computing devices, if required. Such communication may be performed via input/output (I/O) interfaces (not shown).

In some example embodiments, as an alternative of being integrated on a single device, some or all components of the computing system/device 900 may also be arranged in the form of cloud computing architecture. In the cloud computing architecture, the components may be provided remotely and work together to implement the functionalities described in the present disclosure. In some example embodiments, cloud computing provides computing, software, data access and storage service, which will not require end users to be aware of the physical locations or configurations of the systems or hardware provisioning these services. In various embodiments, the cloud computing provides the services via a wide area network (such as Internet) using proper protocols. For example, a cloud computing provider provides applications over the wide area network, which may be accessed through a web browser or any other computing components. The software or components of the cloud computing architecture and corresponding data may be stored in a server at a remote position. The computing resources in the cloud computing environment may be aggregated or distributed at locations of remote data centers. Cloud computing infrastructure may provide the services through a shared data center, though they behave as a single access point for the users. Therefore, the cloud computing infrastructure may be utilized to provide the components and functionalities described herein from a service provider at remote locations. Alternatively, they may be provided from a conventional server or may be installed directly or otherwise on a client device.

The computing system/device 900 may be used to implement resource management in accordance with various embodiments of the present disclosure. The memory 920 may include one or more modules having one or more program instructions. These modules may be accessed and run by the processing unit 910 to perform functions of various embodiments described herein. For example, the memory 920 may include an image editing module 922 for performing image editing in accordance with the example embodiments of the present disclosure. As shown in FIG. 9, the computing system/device 900 may obtain an input required for image editing through the input device 950 and provide the corresponding output through the output device 960. In some example embodiments, the computing system/device 900 may further receive an input from other devices (not shown) via the communication unit 940.

In some example embodiments of the present disclosure, there is provided a computer program product comprising instructions which, when executed by a processor of an apparatus, cause the apparatus to perform steps of any one of the methods described above.

In some example embodiments of the present disclosure, there is provided a non-transitory computer readable medium comprising program instructions for causing an apparatus to perform at least steps of any one of the methods described above. The computer readable medium may be a non-transitory computer readable medium in accordance with some embodiments.

Generally, various example embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of the example embodiments of the present disclosure are illustrated and described as block diagrams, flowcharts, or using some other pictorial representations, it will be appreciated that the blocks, apparatuses, systems, techniques, or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods/processes as described above. Generally, program modules include routines, programs, libraries, objects, classes, components, data structures, or the like that perform particular tasks or implement particular abstract types. The functionality of the program modules may be combined or split between program modules as desired in various embodiments. Computer-executable instructions for program modules may be executed within a local or distributed device. In a distributed device, program modules may be located in both local and remote storage media.

The computer readable medium may be a computer readable signal medium or a computer readable storage medium. A computer readable medium may include but is not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Computer program code for carrying out methods disclosed herein may be written in any combination of one or more programming languages. The program code may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a computer, partly on the computer, as a stand-alone software package, partly on the computer and partly on a remote computer or entirely on the remote computer or server. The program code may be distributed on specially-programmed devices which may be generally referred to herein as “modules”. Software component portions of the modules may be written in any computer language and may be a portion of a monolithic code base, or may be developed in more discrete code portions, such as is typical in object-oriented computer languages. In addition, the modules may be distributed across a plurality of computer platforms, servers, terminals, mobile devices and the like. A given module may even be implemented such that the described functions are performed by separate processors and/or computing hardware platforms.

While operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method comprising:
obtaining a user edit input for a source image, the user edit input at least indicating at least one handle point and at least one target point in the source image;
extracting a feature map from the source image using a diffusion model, the feature map being extracted by the diffusion model at an iteration step of an inverse denoising diffusion process performed on the source image;
updating the feature map based on the user edit input, to obtain an updated feature map; and
generating a target image based on the updated feature map using the diffusion model, the target image being generated by the diffusion model through a denoising diffusion process performed on the updated feature map.

2. The method of claim 1, wherein the diffusion model comprises a base model and a low rank adaptation, LoRA, part connected to the base model, the method further comprising:
performing, based on the source image, a fine-tuning process on a parameter set of the LoRA part of the diffusion model, with a parameter set of the base model unchanged, to obtain an updated diffusion model, and
wherein the extraction of the feature map and the generation of the target image are based on the updated diffusion model.

3. The method of claim 2, wherein performing the fine-tuning process comprises:
performing the fine-tuning process based on a training objective, the training objective being configured to cause the updated diffusion model to reconstruct the source image from a noised image, the noised image being generated by adding a noise signal on the source image.

4. The method of claim 2, wherein the LoRA part comprises at least a part of one or more attention modules comprised in the diffusion model.

5. The method of claim 1, wherein updating the feature map based on the user edit input comprises:
updating the feature map in an iteration process based on an optimization objective, the optimization objective being configured to cause a difference between a first feature segment of a first patch around the at least one handle point in the feature map and a second feature segment of a second patch around the at least one target point in the updated feature map to be minimized or to be reduced to a target error.

6. The method of claim 5, wherein the user edit input further indicates an editable region in the source image, and wherein the optimization objective is configured to cause a feature segment corresponding to a region outside the editable region to be unchanged.

7. The method of claim 5, wherein updating the feature map in an iteration process comprises:
at each iteration step of the iteration process, determining a motion supervision loss by:
obtaining an intermediate feature map that is the feature map at an initial iteration step or an intermediate feature map updated from a previous iteration step,
extracting a first intermediate feature segment from a first patch of the intermediate feature map around the at least one handle point in the intermediate feature map;
extracting a second intermediate feature segment from a second patch of the intermediate feature map around at least one moved handle point in the intermediate feature map, the at least one moved handle point being moved from the at least one handle point towards the at least one target point by a predetermined distance;
determining a motion supervision loss based on a difference between the first intermediate feature segment and the second intermediate feature segment;
updating the intermediate feature map to generate an updated intermediate feature map for a next iteration step by performing gradient backpropagation using the motion supervision loss, wherein a gradient is not backpropagated through the first intermediate feature segment.

8. The method of claim 7, wherein updating the feature map in an iteration process comprises:
updating the at least one handle point for the updated intermediate feature map to be at least one point that is selected a patch among the at least one handle point in the feature map through a nearest neighbor search.

9. The method of claim 1, wherein the diffusion model comprises a self-attention module with a key, a value, and a query as inputs, and wherein generating a target image based on the updated feature map using the diffusion model comprises:
performing the denoising diffusion process on the feature map by the diffusion model, to obtain a first key, a first value, and a first query for the self-attention module;
performing the denoising diffusion process on the updated feature map by the diffusion model, to obtain a second key, a second value, and a second query for the self-attention module;
providing the first key, the first value, and the second query as inputs to the self-attention module;
generating a target image based on an output of the self-attention module.

10. The method of claim 1, wherein the inverse denoising diffusion process comprises a total number of iteration steps, and the feature map is extracted at an iteration step that is within a range of sixty percentage or eighty percentage of the total number of iteration steps.

11. An electronic device, comprising:
at least one processor; and
at least one memory communicatively coupled to the at least one processor and comprising computer-readable instructions that upon execution by the at least one processor cause the at least one processor to perform acts comprising:
obtaining a user edit input for a source image, the user edit input at least indicating at least one handle point and at least one target point in the source image;
extracting a feature map from the source image using a diffusion model, the feature map being extracted by the diffusion model at an iteration step of an inverse denoising diffusion process performed on the source image;
updating the feature map based on the user edit input, to obtain an updated feature map; and
generating a target image based on the updated feature map using the diffusion model, the target image being generated by the diffusion model through a denoising diffusion process performed on the updated feature map.

12. The electronic device of claim 11, wherein the diffusion model comprises a base model and a low rank adaptation, LoRA, part connected to the base model, the device further comprising:
performing, based on the source image, a fine-tuning process on a parameter set of the LoRA part of the diffusion model, with a parameter set of the base model unchanged, to obtain an updated diffusion model, and
wherein the extraction of the feature map and the generation of the target image are based on the updated diffusion model.

13. The electronic device of claim 12, wherein performing the fine-tuning process comprises:
performing the fine-tuning process based on a training objective, the training objective being configured to cause the updated diffusion model to reconstruct the source image from a noised image, the noised image being generated by adding a noise signal on the source image.

14. The electronic device of claim 12, wherein the LoRA part comprises at least a part of one or more attention modules comprised in the diffusion model.

15. The electronic device of claim 11, wherein updating the feature map based on the user edit input comprises:
updating the feature map in an iteration process based on an optimization objective, the optimization objective being configured to cause a difference between a first feature segment of a first patch around the at least one handle point in the feature map and a second feature segment of a second patch around the at least one target point in the updated feature map to be minimized or to be reduced to a target error.

16. The electronic device of claim 15, wherein the user edit input further indicates an editable region in the source image, and wherein the optimization objective is configured to cause a feature segment corresponding to a region outside the editable region to be unchanged.

17. The electronic device of claim 15, wherein updating the feature map in an iteration process comprises:
at each iteration step of the iteration process, determining a motion supervision loss by:
obtaining an intermediate feature map that is the feature map at an initial iteration step or an intermediate feature map updated from a previous iteration step,
extracting a first intermediate feature segment from a first patch of the intermediate feature map around the at least one handle point in the intermediate feature map;
extracting a second intermediate feature segment from a second patch of the intermediate feature map around at least one moved handle point in the intermediate feature map, the at least one moved handle point being moved from the at least one handle point towards the at least one target point by a predetermined distance;
determining a motion supervision loss based on a difference between the first intermediate feature segment and the second intermediate feature segment;
updating the intermediate feature map to generate an updated intermediate feature map for a next iteration step by performing gradient backpropagation using the motion supervision loss, wherein a gradient is not backpropagated through the first intermediate feature segment.

18. The electronic device of claim 17, wherein updating the feature map in an iteration process comprises:
updating the at least one handle point for the updated intermediate feature map to be at least one point that is selected a patch among the at least one handle point in the feature map through a nearest neighbor search.

19. The electronic device of claim 11, wherein the diffusion model comprises a self-attention module with a key, a value, and a query as inputs, and wherein generating a target image based on the updated feature map using the diffusion model comprises:
performing the denoising diffusion process on the feature map by the diffusion model, to obtain a first key, a first value, and a first query for the self-attention module;
performing the denoising diffusion process on the updated feature map by the diffusion model, to obtain a second key, a second value, and a second query for the self-attention module;
providing the first key, the first value, and the second query as inputs to the self-attention module;
generating a target image based on an output of the self-attention module.

20. A non-transitory computer-readable storage medium, storing computer-readable instructions that upon execution by a device cause the device to perform acts comprising:
obtaining a user edit input for a source image, the user edit input at least indicating at least one handle point and at least one target point in the source image;
extracting a feature map from the source image using a diffusion model, the feature map being extracted by the diffusion model at a iteration step of an inverse denoising diffusion process performed on the source image;
updating the feature map based on the user edit input, to obtain an updated feature map; and
generating a target image based on the updated feature map using the diffusion model, the target image being generated by the diffusion model through a denoising diffusion process performed on the updated feature map.
